(19) United States
(12) Patent Application Publication
(10) Pub. No.: US 2024/0140236 A1
(43) Pub. Date: May 2, 2024

(54) CHARGING POLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 18/245,003

(22) PCT Filed: Sep. 6, 2021
(86) PCT No.: PCT/EP2021/074500

§ 371 Date: Mar. 13, 2023

(30) Foreign Application Priority Data
Sep. 11, 2020 (DE) 10 2020 123 798.7

(51) Int. Cl. B60L 53/53; B60L 53/57

(52) U.S. Cl. CPC B60L 53/53; B60L 53/57

(57) ABSTRACT

The invention relates to a method for generating and delivering charging current for an electric vehicle in a charging pole with the method steps of registering a first initial process, evaluating the first initial process, starting the charging process as a function of the evaluation result, wherein the first initial process is different from a start command of a user for starting a charging process, and a charging pole for carrying out the method.

The invention relates to a method for delivering charging power for an electric vehicle and for storing electric power in a charging column, having the method steps of starting an operation for charging an electric vehicle, starting the charging of a battery in the charging pole, ending the operation for charging an electric vehicle, ending the charging of a battery in the charging pole, the charging of the electric vehicle and charging of the battery in the charging pole taking place in parallel.

### STATE OF THE ART

The spread of electric vehicles powered by an electric motor must be accompanied by a functioning infrastructure for charging electric vehicles. In addition to charging at the household socket, users of electric vehicles must be given the opportunity to obtain energy in public areas. With the currently available ranges of electric vehicles, it is necessary that charging of the vehicles is also possible outside the domestic environment. Therefore, charging stations must be made available in public areas to ensure a constant availability of energy for electric vehicles through a supply network.

Charging poles are known for recharging the traction battery of a plug-in vehicle—hybrid or electric vehicle—which have a rechargeable electrical energy storage unit (battery) to deliver the electrical energy stored therein to an electric vehicle to be charged as required. Such a charging pole is disclosed, for example, in DE 10 2010 043 516 A1. The charging pole disclosed here is connected to a power grid that provides the electrical energy for charging an electric vehicle. Such a charging pole requires high connection costs, especially for fast charging of an electric vehicle, cannot be set up flexibly and is not scalable if the charging power is to be increased.

Charging poles are also known which have an energy conversion device located in the charging pole, e.g. an internal combustion engine. Such charging poles do not have an electrical energy storage device that can be used, for example, to briefly increase the charging power of the charging pole.

It is therefore the objective of the present invention to provide a method for charging electric vehicles that enables charging to be carried out more quickly and at lower cost.

The objective is solved by means of the method for generating and delivering charging current for an electric vehicle in a charging pole according to claim 1. Further advantageous embodiments of the invention are set out in the subclaims.

The method according to the invention for generating and delivering charging current for an electric vehicle in a charging pole has four process steps: In the first process step, a process for charging an electric vehicle is started. The charging process for charging an electric vehicle starts with the registration of a first initial process for charging an electric vehicle.

The first initial process can be carried out, for example, by registering the user via, for example, a smartphone. It is also possible to register an electric vehicle to be charged by sensors arranged in the charging pole, by entering data into the HMI unit or by connecting the charging cable to the electric vehicle to be charged. Alternatively or additionally, an energy conversion of an energy conversion device may start. Also alternatively or additionally, the start of a charging process of an electric vehicle can start by connecting the charging cable to the electric vehicle to be charged and a user giving a start command to start charging.

In the second process step, charging of a battery arranged in the charging pole is started. In the third method step, a process for charging an electric motor vehicle is terminated. The charging of an electric motor vehicle can be performed by disconnecting the charging cable or by inputting a stop command from a user. In the fourth process step, the charging of a battery arranged in the charging pole is terminated. Usually, when the charging of an electric motor vehicle ends, the charging of the battery is also stopped. However, it is also possible to continue charging the battery, e.g. when the battery charge level is low. According to the invention, charging of the electric vehicle and charging of the battery arranged in the charging pole take place in parallel.

For the purposes of this document, a process for charging an electric vehicle and a charging process (used synonymously) are understood to include not only the delivery of electrical energy to an electric vehicle but also the start and termination of the delivery of electrical energy to an electric vehicle. Also for the purposes of this document, a process for charging an electric vehicle is understood to mean in particular the start of an energy conversion, e.g. from a liquid and/or gaseous energy carrier into electrical energy, the actual process of energy conversion and the termination of energy conversion. An electric vehicle within the meaning of this document is a motor vehicle which is at least partially driven by an electric motor which, in order to drive the motor vehicle, must be supplied with electricity from an electrical energy storage device arranged in the motor vehicle. Such electric vehicles are e.g. pure electric vehicles (BEV), furthermore plug-in hybrid vehicles, e-scooters, e-scooters, e-bikes. In this document, the term battery is understood to mean any form of energy storage device for storing electrical energy, also devices like a flywheel or electrolysis.

For the purposes of this disclosure, a charging pole is understood to be a charging device which, due to its compact design, can find space on a narrow pavement or can replace a fuel dispenser at a petrol station, but has a maximum space smaller than the space of a standard car parking space. The charging pole is designed as a column, i.e. it has a height H which is at least 20% greater than its width B and/or depth T. A charging pole within the meaning of the present invention does not have a space which can be entered by a human being. A charging pole is therefore neither a container nor a building. Rather, the charging poles according to the invention has a very compact design in which the structure is adapted to the designated space and not—as in container solutions, for example—the standard size of the enclosure dictates the external dimensions. In the charging pole according to the invention, the ratio of the volume V_{N} used by components and/or the air ducting for cooling to the enclosed volume V_{G} is therefore 0.8 or more (V_{N}/V_{G}>0.8), preferably 0.85 (V_{N}/V_{G}>0.85) or more and particularly preferably 0.9 or more (V_{N}/V_{G}>0.9). The maximum dimensions of the charging pole according to the invention are a length of 5 m, preferably of 4.5 m particularly preferably of 3 m with a width of maximum 2.5 m, preferably of 2.25 m, particularly preferably of 2 m. The height is a maximum of 3 m, preferably 2.5 m, particularly preferably 2.25 m.

In a further embodiment of the invention, the charging pole is suitable and intended for charging electric vehicles with a charging power of >75 kW, preferably >100 kW and particularly preferably >125 kW. The charging of an electric vehicle is thus carried out with a charging power>50 kW, preferably >100 kW and particularly preferably >125 kW. This has the advantage that electric vehicles can be charged quickly and only require a short time at the charging pole.

In a further development of the method according to the invention, the charging power delivered to the electric vehicle during a charging process is greater than the charging power provided by an external and/or internal energy source. This has the advantage that the charging time can be considerably reduced by using an additional energy storage device. The external energy source can be a mains connection connected to the mains or an external generator unit. The internal energy source can be an energy conversion unit designed and suitable for generating electrical energy by energy conversion.

The battery located in the charging pole usually supplies electrical energy to the components located in the charging pole. Therefore, a controlled charging of the battery during the charging process of the electric motor vehicle uses the electrical energy generated by the energy conversion device of the charging pole more efficiently. In addition, the energy conversion device can be operated in an optimal operating mode, e.g. a beneficial load. The same applies to a rectifier.

In another embodiment of the invention, the electrical energy is generated in the charging pole. The energy conversion unit generates a primary charging current. Preferred is an energy conversion from a liquid and/or gaseous energy carrier into a charging current, e.g. by means of an internal combustion engine or a fuel cell. However, the energy conversion unit can also be a solar cell that converts light into a current or a rectifier that converts alternating current into direct current. It is also possible to generate a charging current by wind power. In such a design, the charging pole can be operated autonomously and at the same time can be flexible located.

In a further embodiment of the invention, the electrical energy is generated in the charging pole by converting a gaseous and/or liquid energy carrier into electrical current. The energy conversion takes place in an energy conversion unit that generates a primary charging current. Preferred is an energy conversion from a liquid and/or gaseous energy carrier into a charging current, e.g. by means of an internal combustion engine or a fuel cell. Advantageously, the combustion engine M is preferably operated with methanol or ethanol or a mixture of methanol and ethanol. Both types of fuel can be produced from biomass in an environmentally friendly manner, have been established worldwide as fuels for a long time and are therefore available at low cost. Their transport and storage as well as their operation in internal combustion engines are comparable to conventional petrol (for motor vehicles) and thus unproblematic.

In a further development of the invention, the generation of electrical energy in the charging pole takes place in parallel with the charging of the battery and/or the electric vehicle. An energy conversion unit generates a primary charging current with which an electric vehicle is charged. If the nominal power of the charging pole is greater than the charging power delivered to the electric vehicle, at most the difference between the nominal power of the charging pole and the charging power delivered to the electric vehicle is used to charge the battery.

In another embodiment of the invention, during the charging process with two t₁ and t₂ with t₁<t₂, the relationship P_{B}(t₁)>P_{B}(t₂) with P_{B}(t₁) as the charging power for charging the battery at time t₁ and P_{B}(t₂) as the charging power of charging to the battery at time t₂. The system needs a certain time until it is ready to deliver power. For example, until the energy conversion unit is ready to provide the maximum charging power, it takes a certain time until time t₁ when the energy conversion unit has reached the operating temperature and the required speed. All of the charging power generated up to this time t₁ is completely fed into the battery for its charging. At time t₂, the slope of the increase in charging power delivered to the electric motor vehicle to be charged is at a maximum.

In a further embodiment of the invention, the time t₂ lies between the start of the charging process t₀ and a time t_{A}<0,3*t_{G} with t_{G} as the total duration of the charging process. At time t₂, the slope of the increase in the charging power delivered to the electric motor vehicle to be charged is at a maximum. The time t_{A} denotes the time at which the slope of the charging power of the electric motor vehicle to be charged decreases. The increase in the charging power delivered to the electric motor vehicle thus decreases. At time t_{A}, a charging power of the electric motor vehicle to be charged of approx. 90% of the maximum charging power is reached. At the same time, the curve of the charging power delivered to the battery flattens out. The time t_{A} depends on the type of electric vehicle to be charged.

In another embodiment of the invention, during a charging process with two times t₃ and t₄ with t₃<t₄, the relationship P_{B(3)}<P_{B(4)} applies with P_{B(3)} as the charging power of the charging of the battery at time t₃ and P_{B(4)} as the charging power of the charging of the battery at time t₄. From time t₃ onwards, the negative slope of the drop in the charging power of the electric motor vehicle is at a maximum, i.e. the charging power decreases rapidly. At the same time, time t₃ denotes the maximum of the positive slope of the increase in the battery's charging power following this time. The charging power of the battery therefore increases rapidly. At time t₄, the negative slope of the decrease in the charging power of the electric motor vehicle is at a maximum, and at the same time the positive slope of the increase in the charging power of the battery is at a maximum.

In a further development of the invention, the time t₄ lies after the time t₃. The time t₄ designates a time between the time t₃ and the time of the end of the charging process. The time t₃ designates the maximum of the positive slope of the increase in the charging power of the battery following this time.

In a further embodiment of the invention, the time t₃ lies between the end of the charging process t_{G} and a time t_{B}, where t_{B}>0.5*t_{G} with t_{G} as the total duration of the charging process. From time t₃ onwards, the negative slope of the drop in the charging power of the electric motor vehicle is at a maximum, i.e. the charging power decreases rapidly. The time t_{B} designates a plateau of the course of the curves of the charging power of the electric motor vehicle and the charging power of the battery, in which the charging power of an electric motor vehicle is maximum and correspondingly the charging power of the battery is minimum.

In a further embodiment of the invention, the charging power of the charging pole battery passes through a minimum during an entire charging process. In particular, the charging power of the charging of the battery reaches a minimum when the charging power of the electric vehicle reaches a maximum. The charging power of the battery charging can also reach a value of 0 when the entire power of the charging pole is required for charging an electric vehicle.

In a further embodiment of the invention, during a charging process at a time t₁₁ d the relationship P_{B}(t₁₁)>P_{E}(t₁₁) applies with P_{B}(t₁₁) as the charging power of the charging of the battery at time t₁₁ and P_{E}(t₁₁) as the charging power of the charging of the electric vehicle at time t₁₁.

In another embodiment of the invention, the time t₁₁ is between the start of the charging process t₀ and a time t_{A}, where t_{A}<0.3*t_{G} with t_{G} being the total duration of the charging process.

In a further embodiment of the invention, during a charging process at a time t₃₃, the relationship P_{B}(t₃₃)<P_{E}(t₃₃) applies with P_{B}(t₃₃) as the charging power of the charging of the battery at time t₃₃ and P_{E}(t₃₃) as the charging power of the charging of the electric motor vehicle at time t₃₃. At time t_{M}, later than time t_{A}, the charging power of the electric motor vehicle reaches the global maximum, at the same time the global minimum of the charging power of the battery is at this time. In one embodiment of the invention, time t₃₃ is the time exactly halfway between time t_{A} and time t_{M}.

In a further embodiment of the invention, the time t₃₃ is after the time t₁₁. In a further embodiment of the invention, the time t₃₃ is before the end of the charging process t_{G} and a time t_{B}, where t_{B}>0.5*t_{G} with t_{G} as the total duration of the charging process. The time t_{B} designates a plateau of the course of the curves of the charging power of the electric motor vehicle and the charging power of the battery, in which the charging power of an electric motor vehicle is at a maximum and correspondingly the charging power of the battery is at a minimum.

In a further embodiment of the invention, during a charging process at a time t₅, the relationship P_{B}(t₅)=P_{E}(t₅) applies with P_{B}(t₅) as the charging power for charging the battery at time t₅ and P_{E}(t₅) as the charging power for charging the electric vehicle at time t₅. At time t₅, the outputs for the charging power for charging the battery and charging the electric motor vehicle reach the same values.

In another embodiment of the invention, the energy delivered during a charging process for charging the battery of the charging station and/or the electric vehicle is provided by an energy conversion device, wherein the energy conversion device converts a liquid and/or gaseous energy carrier into electrical energy. The energy conversion takes place in an energy conversion unit that generates a primary charging current. Preferred is an energy conversion from a liquid and/or gaseous energy carrier into a charging current, e.g. by means of an internal combustion engine or a fuel cell. Advantageously, the combustion engine is preferably operated with methanol or ethanol or a mixture of methanol and ethanol. Both types of fuel can be produced from biomass in an environmentally friendly manner, have been established worldwide as fuels for a long time and are therefore available at low cost. Their transport and storage as well as their operation in internal combustion engines are comparable to conventional petrol (for motor vehicles) and thus unproblematic.

In a further development of the invention, a computer program for controlling the process for delivering charging current for an electric vehicle and for storing electric current in a charging pole controls the process according to the invention. The computer program is arranged in a device in the charging pole itself, or on a central server connected to the charging pole.

Examples of embodiments of the method according to the invention for the generating and delivering charging current in a charging pole for an electric vehicle are shown schematically in simplified form in the drawings and are explained in more detail in the following description.

Showing:

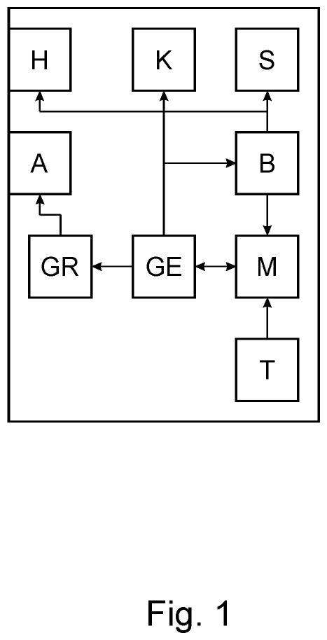

FIG. 1: An embodiment of a charging pole with which the method according to the invention is carried out

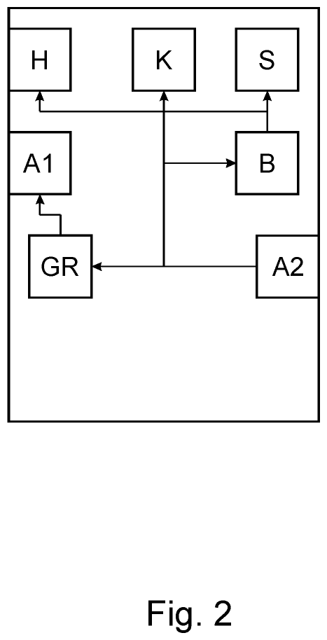

FIG. 2: A further embodiment of a charging pole with which the method according to the invention is carried out

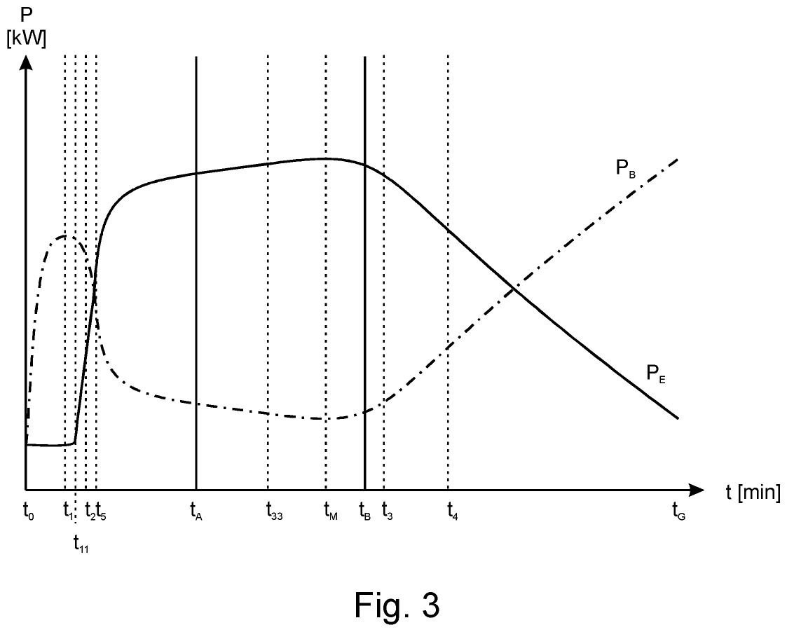

FIG. 3: An example of a power-time diagram during the execution of the method according to the invention

An embodiment of a charging pole 1, with which the method according to the invention is carried out, is shown in FIG. 1. The charging pole 1 has an energy conversion device for generating electrical energy, in this embodiment an internal combustion engine M. The internal combustion engine M is usually a piston combustion engine, but other designs such as a Wankel engine or turbine are also possible. Advantageously, the internal combustion engine M is preferably operated with methanol or ethanol or a mixture of methanol and ethanol. Both types of fuel can be produced from biomass in an environmentally friendly way, have been established as fuels worldwide for a long time and are therefore available at low cost. Their transport and storage as well as their operation in internal combustion engines are comparable to conventional petrol (for motor vehicles) and thus unproblematic. The storage of the fuel in the charging station 1 according to the invention takes place in an energy storage device (tank) T.

The combustion engine M drives the generator GE by rotation. The kinetic energy generated by the combustion engine M is thus converted by the generator GE into electrical energy, into an alternating current. The alternating current generated by the generator GE is converted into a direct current in the rectifier GR, which is fed to the connection device A.

The connection device A has one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current on the basis of this data. The control unit S also has a memory on which a software programme is stored with which the method according to the invention for generating and delivering charging current for an electric vehicle is carried out and controlled.

Furthermore, an electrical energy storage device B (rechargeable battery) is installed in the charging pole 1. The energy storage B supplies the control unit S, by means of which the charging pole 1 detects and initiates the start or completion of a charging process. The electrical energy required for the operation of the charging pole 1 is supplied by the rechargeable energy storage B.

The HMI unit H has a display and operating device on which the data important to a user, such as charging current, charging time and costs of the charging process, are called up and displayed. In addition, a user can initiate or end the charging process and pay. Various payment systems are possible, e.g. via different credit cards. Other payment systems are also possible, e.g. via a mobile terminal (smartphone). The charging pole 1 is connected to the operator of the charging pole 1 and a plurality of charging poles via the communication unit K, which establishes an internet connection, e.g. with a management system or alternatively with a cloud storage. All the aforementioned components of the charging pole 1 are advantageously arranged in the charging pole 1 itself. For this purpose, the charging pole 1 has a housing that protects the components inside the charging pole 1 from the effects of the weather and damage.

The method according to the invention for delivering charging current to an electric motor vehicle begins with the start of a process for charging an electric vehicle. In the second process step, the charging of a battery B arranged in the charging pole is started and carried out. The charging of an electric vehicle and the charging of the energy storage device B advantageously take place in parallel in terms of time. The charging power of the energy storage device B is controlled in such a way that charging an electric vehicle has priority, i.e. charging an electric vehicle takes place with the highest possible power in order to keep the time of the charging process as short as possible. If the nominal power of the charging pole 1 is greater than the charging power delivered to the electric vehicle, only the maximum difference between the nominal power of the charging pole 1 and the charging power delivered to the electric vehicle is used for charging the battery B. If at any time during the charging process the nominal power of the combustion engine M is less than the maximum possible charging power that can be delivered to the electric vehicle, additional charging power is provided by the energy storage device B and delivered to the electric vehicle. In this case, the charging power delivered to the electric vehicle can exceed the charging power of the combustion engine. In a specific case, the maximum charging power during the charging process of an electric vehicle is 100 kW. The combustion engine M provides a charging power of 85 kW, additional the energy storage device B provides a charging power of 15 kW in parallel.

In the third process step, a process for charging an electric vehicle is terminated. In the fourth process step, the charging of a battery B arranged in the charging pole is terminated. The third and fourth process steps are usually carried out simultaneously, i.e. when charging of an electric motor vehicle ends, charging of battery B is also stopped. However, it is also possible to continue charging the battery B, e.g. when the charge level of the battery B is low, or to stop charging the battery B when the charge level is high.

FIG. 2 shows a further embodiment of a charging pole 1 with which the method according to the invention is carried out. In this embodiment example, the charging pole 1 uses an external energy source, e.g. the public power grid, to charge an electric vehicle. The supply line is provided via the connection device A2, which is connected to the HMI unit H, the control unit S and the communication unit K and supplies them with electrical energy. The connection device A2 is also connected to the rectifier GR, which converts the alternating current of the power grid into a direct current. The direct current is supplied to an electric vehicle via the connection device A1 connected to the rectifier GR and the charging cable connected to the connection device A1. The energy storage device B is also connected to the connection device A2 and is supplied with electrical energy through it. In addition, the control unit S has a memory unit on which a software program is stored with which the method according to the invention for generating and delivering charging current for an electric vehicle is carried out and controlled. All the aforementioned components of the charging pole 1 are arranged in the charging pole 1 within a housing G.

The method according to the invention for delivering charging current to an electric motor vehicle begins with the start of a process for charging an electric vehicle. In the second process step, the charging of a battery B arranged in the charging pole is started and carried out. The charging of an electric vehicle and the charging of the energy storage device B advantageously take place in parallel in terms of time. The charging power of the energy storage device B is controlled in such a way that charging an electric vehicle has priority, i.e. charging an electric vehicle takes place with the highest possible power in order to keep the time of the charging process as short as possible. If the nominal power of the charging pole 1 is greater than the charging power delivered to the electric vehicle, only the maximum difference between the nominal power of the charging pole 1 and the charging power delivered to the electric vehicle is used for charging the battery B.

In the third process step, a process for charging an electric vehicle is terminated. In the fourth process step, the charging of a battery arranged in the charging pole is terminated. The third and fourth process steps are usually carried out simultaneously, i.e. when charging of an electric motor vehicle ends, charging of battery B is also stopped. However, it is also possible to continue charging the battery B, e.g. when the charge level of the battery B is low.

A power-time diagram (P,t) of an embodiment of the method according to the invention is shown in FIG. 3. The course of the charging power P is shown here for an electric motor vehicle to be charged, which has an active temperature control of the battery of the electric motor vehicle in order to avoid damage to the battery of the electric motor vehicle during the charging process and at the same time to enable a high charging power with direct current. The charging pole 1 used is of the type shown in FIG. 1, i.e. it has an energy conversion device, in this case an internal combustion engine M.

Zum Zeitpunkt t₀ wird die Energiekonversion der Energiekonversionsvorrichtung M gestartet, es erfolgt die Energiekonversion des in der Tankeinheit T gelagerten Kraftstoffs in elektrische Energie durch den Verbrennungsmotor M. Der Motor M benötigt bis zum Bereitstellen der maximalen Ladeleistung, in diesem Ausführungsbeispiel 200 kW, eine bestimmte Zeit bis zum Zeitpunkt t₁, bei dem der Motor M die Betriebstemperatur und die erforderliche Drehzahl erreicht hat. Der Motor M wird durch diesen Vorgang geschont, der Verschleiß vermindert. Die gesamte bis zu diesem Zeitpunkt t₁ erzeugte Ladeleistung wird vollstandig in die Batterie B zu deren Aufladung geleitet. Der Zeitpunkt t₁ liegt in diesem Ausfuhrungsbeispiel bei 30 s nach dem Zeitpunkt t₀ und markiert ein lokales Maximum der Ladeleistung der Batterie B. Ab dem Zeitpunkt t₁ steigt daher sehr steil die Ladeleistung, die an das zu ladende Elektro-Kraftfahrzeug abgegeben wird, wahrend die an die Batterie B abgegebene Leistung ebenso steil sinkt.

At time t₀, the energy conversion of the energy conversion device M is started, the energy conversion of the fuel stored in the tank unit T into electrical energy is carried out by the combustion engine M. The engine M requires a certain time until the maximum charging power is provided, in this embodiment example 200 kW, until time t₁, at which the engine M has reached the operating temperature and the required revolutions per time unit. The motor M is protected by this process and wear is reduced. The entire charging power generated up to this time t₁ is completely fed into the battery B for its charging. In this example, time t₁ is 30 s after time t₀ and marks a local maximum of the charging power of battery B. From time t₁, the charging power delivered to the electric vehicle to be charged increases very steeply, while the power delivered to battery B decreases just as steeply.

At time t₂ (50 s after time t₀), the slope of the increase in charging power delivered to the electric vehicle to be charged is at a maximum. At time t₅ (1 min after time t₀), the power for charging battery B and charging the electric vehicle reach the same values.

The time t_{A} designates the time at which the slope of the charging power of the electric motor vehicle to be charged decreases. The increase in the charging power delivered to the electric motor vehicle therefore decreases. At time t_{A}, the charging power of the electric motor vehicle to be charged reaches 90% of the maximum charging power. At the same time, the curve of the charging power delivered to battery B flattens out. The time t_{A} depends on the type of electric vehicle to be charged and is approx. 25-30% of the total charging time t_{G}.

At time t_{M}, later than time t_{A}, the charging power of the electric motor vehicle reaches the global maximum, at the same time the global minimum of the charging power of battery B is at this time. Time t₃₃ denotes the time exactly in the middle between time t_{A} and time t_{M}.

Between time t_{M} and the later time t_{B}, the curves of the charging power of the electric motor vehicle and (correspondingly) the charging power of battery B describe a plateau, i.e. between time t_{M} and time t_{B}, both charging powers remain constant.

The curve of the charging power of the electric motor vehicle decreases after time t_{B}, while the charging power of the battery increases again. From time t₃ following time t_{B}, the negative slope of the decrease in the charging power of the electric motor vehicle is at a maximum, i.e. the charging power decreases rapidly. At the same time, time t₃ denotes the maximum of the positive slope of the increase in the charging power of battery B following this time. The charging power of battery B therefore increases rapidly.

The time t₄ designates a time between the time t₃ and the time of the end of the charging process t_{G}. At this time t₄, the negative slope of the decrease in the charging power of the electric motor vehicle is at a maximum, and at the same time the positive slope of the increase in the charging power of battery B is at a maximum.

The charging process for charging an electric vehicle is completed at time t_{G}. The user terminates the charging process by entering a stop command into the HMI unit H or removes the charging cable from the electric vehicle.

### REFERENCE LIST

1 Charging pole
H HMI unit
GW DC converter
GE Generator
S Control unit
K Communication unit
B Battery/rechargeable battery/rechargeable electric energy storage unit
A Connection device for charging cable
T Tank unit
GR Rectifier
WR Inverter
GGE DC generator
G Housing
M Combustion engine

1. A process for generating and delivering charging current for an electric vehicle in a charging pole (1), having the following steps
Starting an operation to charge an electric vehicle
Start charging a battery (B) in the charging pole (1)
Termination of the process for charging an electric vehicle
Termination of the process of charging a battery (B) in the charging pole (1)
characterised in that
the charging of the electric vehicle and the charging of the battery (B) in the charging pole (1) take place simultaneously.

2. The process for generating and delivering charging current for an electric vehicle in a charging pole (1) according to claim 1,
characterised in that
electrical energy is generated in the charging pole (1).

3. The process for generating and delivering charging current for an electric vehicle in a charging pole (1) according to claim 2,
characterised in that
the electrical energy is generated in the charging pole (1) by converting a gaseous and/or liquid energy carrier into an electrical current.

4. The process for generating and delivering charging current for an electric vehicle in a charging pole (1) according to claim 2,
characterised in that
the generation of electrical energy in the charging pole (1) takes place in parallel with the charging of the battery (B) and/or the electric vehicle.

5. The process for generating and delivering charging current for an electric vehicle in a charging pole (1) according to claim 1,
characterised in that
during a charging process with two times t₁ and t₂ with t₁<t₂
P_{B}(t₁)>P_{B}(t₂)
with P_{B}(t₁) as the charging power of the charging of the battery (B) at time t₁ and P_{B}(t₂) as the charging power of the charging of the battery (B) at time t₂.

6. The process for generating and delivering charging current for an electric vehicle in a charging pole (1) according to 5,
characterised in that
the time t₂ lies between the start of the charging process t₀ and a time t_{A}, where t_{A}<0.3*t_{G} with t_{G} as the total duration of the charging process.

7. The process for generating and delivering charging current for an electric vehicle in a charging pole (1) according to claim 1,
characterised in that
during a charging process with two times t₃ and t₄ with t₃<t₄
P_{B}(t₃)<P_{B}(t₄)
with P_{B}(t₃) as the charging power of the charging of battery (B) at time t₃ and P_{B}(t₄) as the charging power of the charging of battery (B) at time t₄.

8. The process for generating and delivering charging current for an electric vehicle in a charging pole (1) according to claim 7
characterised in that
the time t₃ is after the time t₂.

9. The process for generating and delivering charging current for an electric vehicle in a charging pole (1) according to claim 7,
characterised in that
the time t₃ lies between the end of the charging process t_{E} and a time t_{B}, where t_{B}>0.5*t_{G} with t_{G} as the total duration of the charging process.

10. The process for generating and delivering charging current for an electric vehicle in a charging pole (1) according to claim 1,
characterised in that
during an entire charging process the charging power of the battery (B) of the charging pole (1) passes through a minimum.

11. The process for generating and delivering charging current for an electric vehicle in a charging pole (1) according to claim 1,
characterised in that
during a charging process at a time t₁₁
P_{B}(t₁₁)>P_{E}(t₁₁)
with P_{B}(t₁₁) as the charging power of the battery (B) at time t₁₁ and P_{E}(t₁₁) as the charging power of the electric vehicle at time t₁₁.

12. The process for generating and delivering charging current for an electric vehicle in a charging pole (1) according to claim 11
characterised in that
the time t₁₁ lies between the start of the charging process to and a time t_{A}, where t_{A}<0.3*t_{G} with t_{G} as the total duration of the charging process.

13. The process for generating and delivering charging current for an electric vehicle in a charging pole (1) according to claim 1,
characterised in that
during a charging process at a time t₃₃
P_{B}(t₃₃)<P_{E}(t₃₃)
with P_{B}(t₃₃) as the charging power of the charging of the battery (B) at time t₃₃ and P_{E}(t₃₃) as the charging power of the charging of the electric vehicle at time t₃₃.

14. The process for generating and delivering charging current for an electric vehicle in a charging pole (1) according to claim 1,
characterised in that
the time t₃₃ is after the time t₁₁.

15. The process for generating and delivering charging current for an electric vehicle in a charging pole (1) according to claim 1,
characterised in that
the time t₃₃ lies between the end of the charging process t_{E} and a time t_{B}, where t_{B}>0.5*t_{G} with t_{G} as the total duration of the charging process.

16. The process for generating and delivering charging current for an electric vehicle in a charging pole (1) according to claim 1,
characterised in that
during a charging process at a time t₅
P_{B}(t₅)=P_{E}(t₅)
with P_{B}(t₅) as the charging power of the charging of the battery (B) at time t₅ and P_{E}(t₅) as the charging power of the charging of the electric vehicle at time t₅.

17. The process for generating and delivering charging current for an electric vehicle in a charging pole (1) according to claim 1,
characterised in that
the energy delivered during a charging process for charging the battery (B) of the charging pole (1) and/or the electric vehicle is provided by an energy conversion device (M),
wherein the energy conversion device (M) converts a liquid and/or gaseous energy carrier into electrical energy.

18. Computer program for controlling the process for delivering charging current for an electric vehicle and for storing electric current in a charging pole (1) according to claim 1.
